(19) United States
(12) Patent Application Publication
(10) Pub. No.: US 2025/0326039 A1
(43) Pub. Date: Oct. 23, 2025

(54) Tool For Piercing A PVC Water Main

(71) Applicant: Brian J. Murphy, Monticello, MO (US)

(72) Inventor: Brian J. Murphy, Monticello, MO (US)

(21) Appl. No.: 19/184,719

(22) Filed: Apr. 21, 2025

Related U.S. Application Data
(60) Provisional application No. 63/636,451, filed on Apr. 19, 2024.

(51) Int. Cl. B23B 51/04

(52) U.S. Cl. CPC B23B 51/04; B23B 2215/72

(57) ABSTRACT

A PVC piercing tool for drilling the initial piercing hole in a PVC main water line reduces the amount of heat and stress generated while drilling the hole. The PVC piercing tool removes PVC material around a center drill-hole plug which is removed to provide a piercing hole of suitable diameter.

### CROSS-REFERENCE TO RELATED APPLICATIONS

The present application claims priority from, and incorporates by reference in its entirety, U.S. provisional patent application 63/636,451 filed Apr. 19, 2024.

### BACKGROUND OF THE INVENTION

### Field of the Invention

The present disclosure relates to tools for drilling holes, for example, a bit for piercing a PVC water main with water flowing in it.

### Description of Related Art

FIG. 1A is an oblique view and FIG. 1B is a top view of a polyvinyl chloride (PVC) water main 199. The need often arises to install a gate valve in a water main such as water main 199. The installation of a gate valve requires a slotted hole. FIGS. 1A-B depict a location for a slot shaped hole 105 to be cut in the water main 199 order to install a gate valve-sometimes called a slot gate. To cut the slot shaped hole 105, the water main 199 must first be pierced by drilling a smaller hole. A small piercing hole 103 is cut in the water main first, and this small piercing hole 103 is then used to insert a cutting bit for cutting the larger slot shaped hole 105. If a section of the water main is to be replaced, the small piercing hole 103 may be used to insert a blade or other tool to cut the water main in half.

Tapping into a water main to run a line to a new home or building is preferably done without shutting down the water main and disrupting the service to all the homes and businesses served by the water main. However, tapping into a water main while the water remains flowing and at full pressure is a tricky process that often results in failures such as cracking or damaging the water main PVC class pipe. The water in a water main is maintained at pressures of from 50 to 200 pounds per square inch (psi). If the water main PVC class pipe cracks or is otherwise damaged during the process, the water must be shut off to repair the damage before the gate valve can be installed. Shutting down a water main for several hours is very disruptive and costly to the homes and businesses served by the water main.

The EZ Valve™ tool is a tool system which is often used to drill a piercing hole 103, and then cut the slot shaped hole 105 for a gate valve while the water remains flowing in the water main. In times past, the water mains running beneath city streets to deliver water to the public were typically made of metal such as iron or cast iron. The EZ Valve™ tool works fine for metal water mains. But over the past fifty years water mains 199 made of PVC have become prevalent. For example, Class 160 and Class 200 PVC pipe are two common types of PVC used for new water main installations as well and replacement sections. There are some serious drawbacks in using the conventional piercing bit that comes with the EZ Valve™ tool system for drilling a piercing hole 103 in a PVC water main. The main drawback in using the conventional piercing bit on PVC is the high percentage of the time that drilling the piercing hole 103 results in cracking or otherwise damaging the PVC water main. Using the conventional piercing bit to drill piercing hole 103 results in cracking or damage to the PVC water main 199 approximately 50% of the time.

A typical tool system for used to pierce a water main with piercing hole 103, cut an appropriate sized slot shaped hole 105, and install a gate valve costs over $100,000. Despite the high price of such conventional tools, the small piercing hole 103 which must be drilled first in order to tap into a water main, results in cracking or damage to the water main PVC class pipe around 50% of the time when using a conventional piercing bit. The cost of shutting down a water main to repair damage caused during installation of a gate valve varies widely, depending upon the circumstances and customers served by the water main. A water main to a rural home (without livestock) can be shut down for several hours with minimal cost and inconvenience. However, a water main that serves a busy downtown area or a manufacturing facility could result is hundreds of thousands of dollars in lost sales or manufacturing revenue. A water main shutdown to a residential area might not cause significant monetary damages, but it would result in inconvenience to all the homes served by the water main. One average the cost of shutting down a water main to repair damage caused by gate valve installation could easily be within the range of $10,000 to $20,000.

FIGS. 2A-B depict a conventional piercing/cutting bit 201 used in the EZ Valve™ tool system for drilling the piercing hole 103 in a PVC water main, and then cutting the slot shaped hole 105 for a gate valve. The cutting-edges 217 cut into the PVC pipe for drilling the piercing hole 103. Once the piercing hole 103 is drilled, the conventional piercing/cutting bit 201 is further inserted so that cutting-edges 218 make contact with the PVC pipe material. The EZ Valve™ tool system is then used to manipulate the conventional piercing/cutting bit 201 around the water main allowing the cutting-edges 218 to cut the slot shaped hole 105. Ideally, this is all done while the water remains flowing and under pressure. But if drilling the small piercing hole 103 results in damage to the PVC water main 199—which happens approximately 50% of the time—the water supply must be shut off so repairs can be made before installing the gate valve.

### BRIEF DESCRIPTION OF THE DRAWINGS

Various aspects and advantageous features of the present disclosure will become more apparent to those of ordinary skill in the art from the explanations in the Detailed Description below, and reference to the accompanying drawings, wherein:

FIG. 1A is an oblique view of a PVC water main depicting a location for a hole to be cut in it.

FIG. 1B is a top view of a PVC water main depicting a location for a hole to be cut in it.

FIGS. 2A-B are oblique views of a conventional piercing/cutting bit for drilling a hole in a PVC water main.

FIGS. 3A-B are oblique views of an improved PVC piercing tool for cutting a hole in a PVC water main in accordance with various embodiments of the present invention.

FIG. 3C is a side view of an improved PVC piercing tool for cutting a hole in a PVC water main in accordance with various embodiments of the present invention.

FIG. 4A depicts the cutting-edge contact area for a first type of piercing bit as viewed looking downward on the hole being cut.

FIG. 4B depicts the cutting-edge contact area for a PVC piercing tool as viewed looking downward on the hole being cut, in accordance with various embodiments of the present invention.

### DETAILED DESCRIPTION

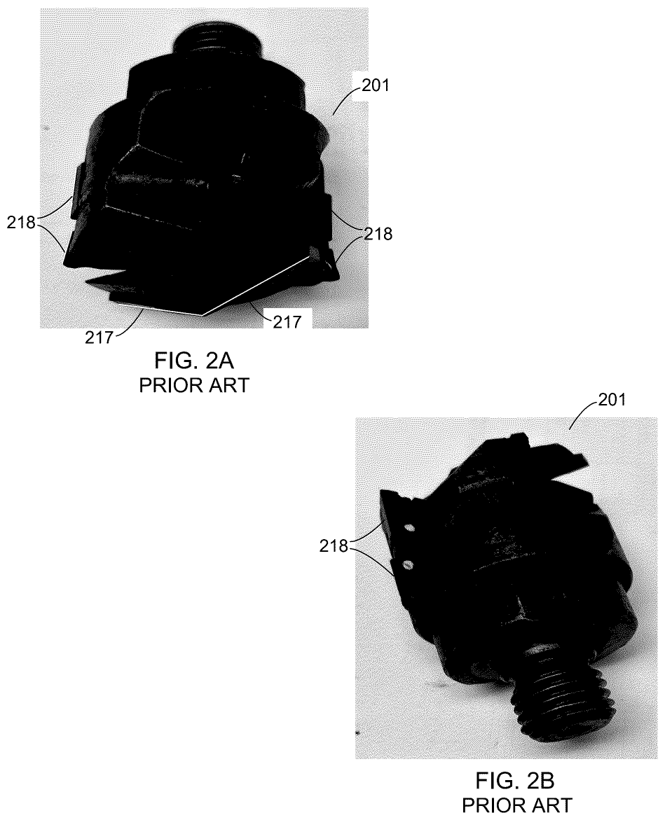

The present inventor realized that damage and cracking to the PVC while drilling the piercing hole 103 is largely due to excessive heat buildup while the hole is being drilled and deformation of the PVC pipe from the downward pressure applied during the drilling process. This occurs for the following reasons. The center point of a conventional piercing/cutting bit 201 of FIGS. 2A-B is pressed into the center of the location for the piercing hole 103. As it rotates and is pressed downward the cutting-edge 217 of the conventional piercing/cutting bit 201 bites into the PVC material to drill the piercing hole 103. Using the conventional piercing/cutting bit 201 to drill a piercing hole 103 requires at least 22.5 pounds of downward force. The downward force needed for the conventional piercing/cutting bit 201 to bite into the PVC water main 199 and drill the piercing hole 103 in combination with the heat generated during the cutting process causes the water main 199 to deform downward locally. This deformation often results in a non-uniform shaped piercing hole 103. The present inventor also recognized problems caused by the heat generated by the piercing/cutting bit 201 during the drilling of piercing hole 103.

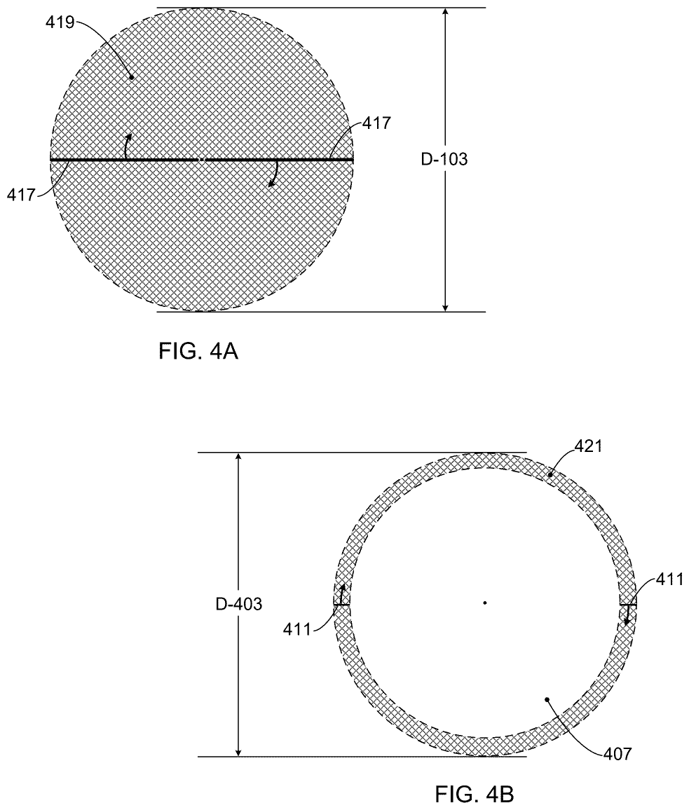

FIG. 4A depicts the cutting-edge contact area for a first type of piercing bit as viewed looking downward on the hole being cut. The two cutting-edges 217 of piercing/cutting bit 201 (of FIGS. 2A-B) extend across the full diameter of the piercing hole 103, slanted downward, as the conventional bit 201 cuts into the round PVC water main 199. This can be seen as cutting-edge contact line 417 in FIG. 4A. Actually, the length of the two cutting-edges 217 taken together exceed the diameter of piercing hole 103 since the two cutting-edges 217 are slanted downwards towards the center point of conventional bit 201. The heat due to cutting the piercing hole 103 is generated as the cutting-edges 217 dig into the PVC material during the drilling operation. The heat generated by a conventional piercing/cutting bit 201 is much greater than the heat generated by a PVC piercing tool 301 according to the various embodiments since the length of the conventional cutting-edges 217 is greater than the length of cutting-edges of the various embodiments of the improved PVC piercing tool 301 described below.

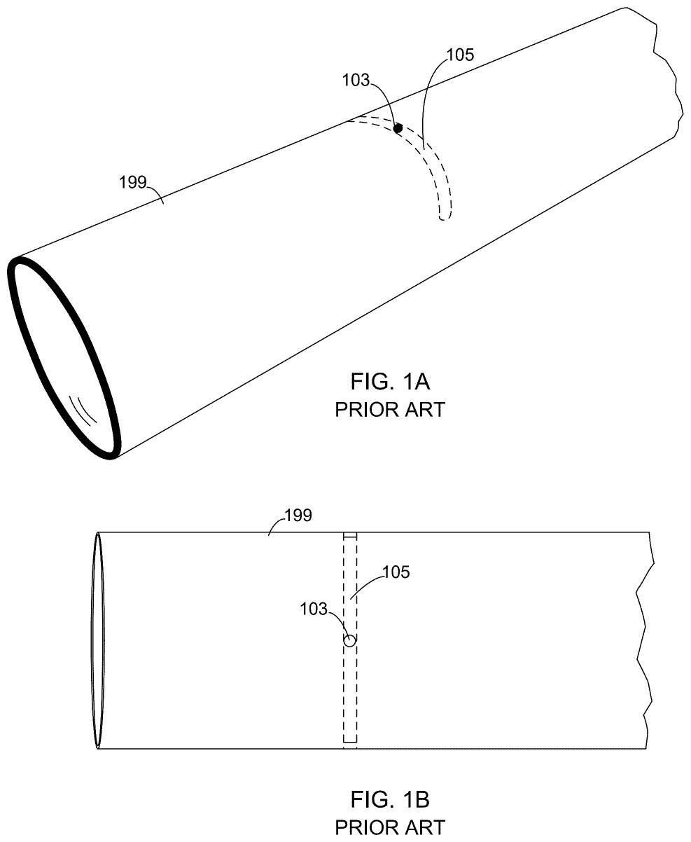

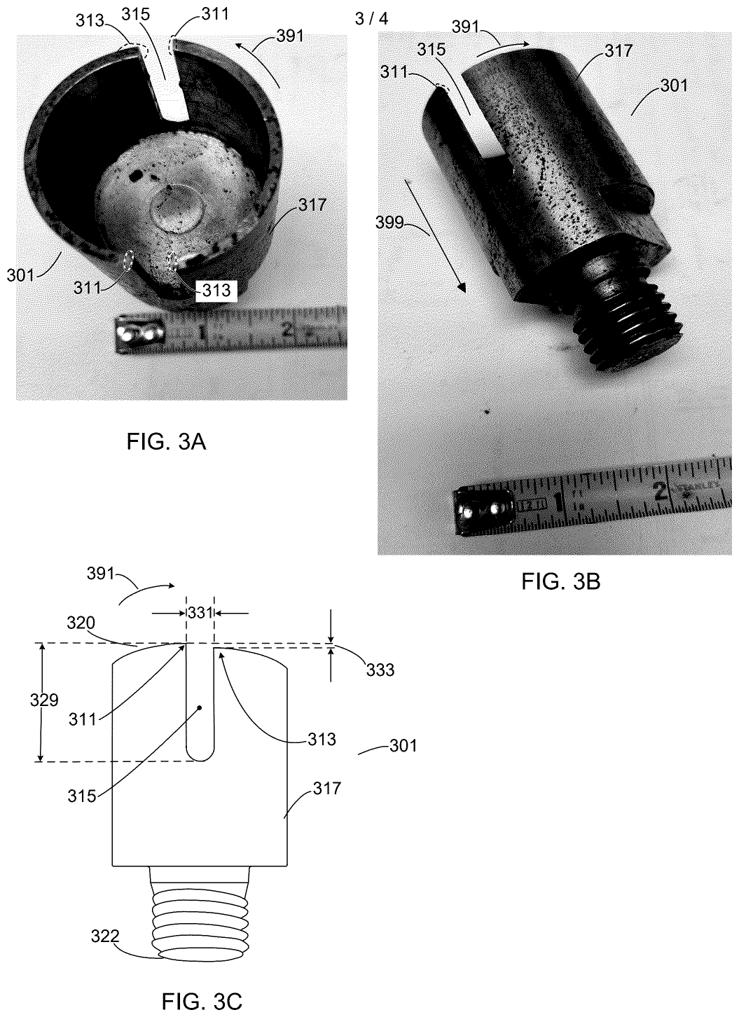

FIGS. 3A-B are oblique views of a PVC piercing tool 301 for cutting a hole in a PVC water main such as water main 199 of FIG. 1A, in accordance with various embodiments of the present invention. The PVC piercing tool 301 may be called a synthetic water main piercing tool 301 since it is designed to pierce water mains made of synthetic materials such as PVC. The proximal direction 399 shown in FIG. 3B points from the distal end of PVC piercing tool 301 towards its proximal end. The distal direction (not shown) points from the proximal end of PVC piercing tool 301 towards its distal end.

The PVC piercing tool 301 is configured to be rotated in rotation direction 391 since the cutting-edges 311 trail the rotation support surfaces 313 as the tool 301 rotates. As the PVC piercing tool 301 is rotated in rotation direction 391 and pressed against water main 199 the PVC cutting-edge 311 removes PVC material to cut the piercing hole 103. The center portion 407 shown in FIG. 4B of the hole being cut comes out in one piece, and does not come into contact with the cutting-edges 311 of PVC piercing tool 301 shown in FIGS. 3A-B. The amount of PVC material removed by PVC piercing tool 301 is much less than the amount of PVC material removed by conventional piercing/cutting bit 201. The differing amounts of PVC material removed for PVC piercing tool 301 as compared to conventional piercing/cutting bit 201 can be seen by comparing the shaded areas of FIGS. 4A and 4B, as discussed below in conjunction with FIGS. 4A-B.

The downward cutting-force for the PVC piercing tool 301 to cut a piercing hole 103 is considerably less than that required for the conventional piercing/cutting bit 201. In accordance with various embodiments, a piercing hole 103 can be cut using the PVC piercing tool 301 with a downward cutting-force of no greater than 17.5 pounds. In other embodiments, the required cutting-force is no greater than 12.5 pounds. In other embodiments, the required cutting-force is no greater than 10.0 pounds. In yet other embodiments, the required cutting-force is no greater than 7.5 pounds.

Since much less PVC material is removed, much less heat is generated by the PVC piercing tool 301 as compared to conventional piercing/cutting bit 201. Further, since less PVC material is removed and the cutting-edges of improved PVC piercing tool 301 are shorter as compared to conventional piercing/cutting bit 201, less downward pressure is needed to bite into the PVC material of water main 199. Less heat being generated and less downward pressure, in turn, leads to a much lower failure rate for the improved PVC piercing tool 301 than the 50% failure rate of conventional piercing/cutting bit 201. The failure rate when using the improved PVC piercing tool 301 is less than 1%.

FIG. 4A depicts the cutting-edge contact area 419 for conventional piercing/cutting bit 201 in drilling a piercing hole 103. The shaded cutting-edge contact area 419 provides an indication of the amount of material removed by conventional piercing/cutting bit 201. FIG. 4B depicts the cutting-edge contact area 421 for PVC piercing tool 301 in accordance with various embodiments of the present invention. The shaded cutting-edge contact area 421 is an indication of the amount of material removed by PVC piercing tool 301. The center piece 407 of the hole being drill does not make contact with the cutting blades. Thus, the amount of PVC material removed by the improved PVC piercing tool 301 is much less than the amount of PVC material removed by the conventional piercing/cutting bit 201. Moreover, since cutting-edge contact line 411 is much less than conventional cutting-edge contact line 417, the PVC piercing tool 301 requires much less downward pressure than conventional piercing/cutting bit 201 to cut a piercing hole into the PVC water main.

Turning again to FIG. 4B, each cutting-edge contact line 411—that is, the PVC material removed by a cutting-edge 311 of PVC piercing tool 301—spans approximately 6% of the diameter D-103 of piercing hole 103. The ratio the length of a cutting-edge 311 to the piercing hole diameter D-103 is known as the cutting-edge to hole-diameter ratio. The cutting-edge to hole-diameter ratio varies somewhat depending upon the piercing hole 103 size and the requirements and particularities of the implementation. In some embodiments the cutting-edge to hole-diameter ratio is no greater than 15/100—meaning that each cutting-edge contact line 411 spans no greater than 15% of the diameter D-103 of piercing hole 103. In other embodiments the cutting-edge to hole-diameter ratio is no greater than 10/100. In yet other embodiments the cutting-edge to hole-diameter ratio is no greater than 8/100.

As shown in FIGS. 3A-B, the PVC piercing tool 301 has a hollow cylindrical bit body 317 with a PVC material slot 315 which may be called material slot 315 on each side. The PVC material slots 315 each open at the distal end of hollow cylindrical bit body 317, and extend down each side of the hollow cylindrical bit body 317 towards its proximal end. The side of a PVC material slot 315 with the cutting-edge 311 is called the trailing slot-side, and the side of slot 315 with the rotation support surface 313 is the leading slot-side of PVC material slot 315. As PVC piercing tool 301 is rotated in direction 391, the rotation support surface 313 leads cutting-edge 311. The embodiment depicted in FIGS. 3A-C has two PVC material slots 315 positioned on opposing sides of the hollow cylindrical bit body 317. Some embodiments have only one PVC material slot 315 in the hollow cylindrical bit body 317. Some embodiments have three PVC material slots 315 positioned around the hollow cylindrical bit body 317. Other embodiments have four or more PVC material slots 315 positioned around the hollow cylindrical bit body 317.

FIG. 3C is a side view of PVC piercing tool 301 for cutting a hole in a PVC water main 199 in accordance with various embodiments of the present invention. The PVC piercing tool 301 has a shank portion 322 extending from the proximal end of the hollow cylindrical bit body 317. The shank portion 322 may be removably attached to a drill or other rotating tool. A threaded shank is shown in the figure. However, other types of removable shanks may be implemented for the various embodiments—e.g., a square shank similar to socket wrench, or a hex shank, or a geared shank-depending up the type of tool being used to provide rotational force to the tool 301.

The cutting end 320 of the PVC piercing tool 301 sometimes called the distal end is opposite the shank portion 322. The cutting end 320 has a PVC material slot 315 extending downward into the tool from the distal end towards the proximal shank portion 322. During the drilling process the bits of PVC material removed from the water main 199 accumulate in the PVC material slot 315. The cutting-edge 311 is on the trailing side of the PVC material slot 315, and the rotation support surface 313 is on the leading edge of the PVC material slot 315. The rotation support surface 313 keeps the cutting-edge 311 from biting in too far as downward force is applied.

As shown in FIG. 3C, the cutting-edge 311 located on the trailing slot-side of PVC material slot 315 extends higher than the rotation support surface 313 located on the leading slot-side of PVC material slot 315. The cutting-edge 311 extends higher than the rotation support surface 313 by the cutting depth 333. Thus, the trailing slot-side of PVC material slot 315 is longer than the leading slot-side by an amount equal to cutting depth 333. As such the cutting-edge 311 makes contact with the PVC material as the PVC piercing tool 301 rotates, digging into the PVC material to a depth equal to the cutting depth 333. As the PVC piercing tool 301 is digging into the PVC material, the rotation support surface 313 keeps the tool 301 from digging in too deeply. Removing too much material in one pass increases the risk of causing strain cracks and possibly building up excessive heat. In various embodiments the cutting depth 333 is at least 0.001 inch and no greater than 0.175 inch. In other embodiments the cutting depth 333 is at least 0.020 inch and no greater than 0.200 inch. In other embodiments the cutting depth 333 is no greater than 0.225 inch. In other embodiments the cutting depth 333 is no greater than 0.200 inch. In other embodiments the cutting depth 333 is no greater than 0.175 inch. In yet other embodiments the cutting depth 333 is no greater than 0.125 inch. In yet other embodiments the cutting depth 333 is no greater than 0.100 inch. In yet other embodiments the cutting depth 333 is no greater than 0.075 inch. Different cutting depths can be used on various different materials. In general, materials that are easier to cut—e.g., softer materials—can have greater cutting depths 333. The width of the cutting-edge 311 also affects the optimal cutting depth 333. Embodiments with wider cutting-edges 311 tend to have shallower cutting depths 333 so as not to remove too much PVC material during each pass (i.e., each rotation).

In some embodiments the slot-width 331 of PVC material slot 315 shown in FIG. 3C is no greater than 0.375 inch across. In other embodiments the slot-width 331 is no greater than 0.500 inch across. In yet other embodiments the slot-width 331 is no greater than 0.750 inch across. In some embodiments the slot-depth 329 of PVC material slot 315 is no less than 0.375 inch deep. In other embodiments the slot-depth 329 of PVC material slot 315 is no less than 0.500 inch deep. In yet other embodiments the slot-depth 329 of PVC material slot 315 is no less than 0.750 inch deep.

The diameter D-103 of the piercing hole 103 drilled by conventional piercing/cutting bit 201 may be the same as the diameter D-403 of the piercing hole cut by PVC piercing tool 301. However, the characteristics of the two piercing holes differ due to the way the holes are drilled. A piercing hole 103 drilled by conventional piercing/cutting bit 201 results in cutting out all the PVC material from the hole 103. This creates enough heat to frequently damage or crack the PVC main water pipe 199 at the edges of piercing hole 103. By contrast, a piercing hole 103 cut by PVC piercing tool 301 results in less PVC material being cut, and a center drill-hole plug 407—called a coupon 407 in the art—being removed in one piece. This leaves a piercing hole 103 of a suitable diameter without cracks or other damage that would necessitate shutting down the water main for expensive repairs. Removing the coupon 407 intact results in a lot less PVC material being cut, and thus a lot less heat being generated, as well as less downward pressure which causes deformation of the PVC water main 199 during the drilling process. The lower amounts of heat and stress from the PVC piercing tool 301 results in failure rate which is less than 1% very near 0% as compared to a 50% failure rate of conventional bits 201 used to drill piercing hole 103.

1. A water main piercing tool apparatus configured to rotate in a rotational direction to cut a piercing hole in a synthetic water main, the apparatus comprising:
a hollow cylindrical bit body including a distal end and a proximal end;
a shank portion extending from the proximal end of the hollow cylindrical bit body;
a material slot formed in the hollow cylindrical bit body, the material slot opening at the distal end of the hollow cylindrical bit body and extending from the distal end towards the proximal end, the material slot including a trailing slot-side and a leading slot-side;
a rotation support surface formed at the leading slot-side towards the distal end of the hollow cylindrical body;
a cutting-edge formed at the trailing slot-side towards the distal end of the hollow cylindrical body;
wherein the trailing slot-side is longer than the leading slot-side by an amount equal to a cutting depth.

2. The synthetic water main piercing tool apparatus of claim 1, further comprising:
a shank portion extending from the proximal end of the hollow cylindrical bit body;
wherein the shank portion is configured to be removably attached to a rotating tool to rotate the water main piercing tool apparatus in the rotational direction.

3. The synthetic water main piercing tool apparatus of claim 2, wherein the shank portion includes male threads configured to removably attached the water main piercing tool apparatus to the rotating tool.

4. The synthetic water main piercing tool apparatus of claim 2, wherein the piercing tool apparatus is configured to cut the piercing hole in response to rotating the piercing tool apparatus in the rotational direction while pressing the piercing tool apparatus against the synthetic water main with a force equal or greater than a cutting-force.

5. The synthetic water main piercing tool apparatus of claim 4, wherein the cutting-force is no greater than 17.5 pounds.

6. The synthetic water main piercing tool apparatus of claim 5, wherein the cutting-force is no greater than 10.0 pounds.

7. The synthetic water main piercing tool apparatus of claim 1, the cutting depth is no greater than 0.200 inch.

8. The synthetic water main piercing tool apparatus of claim 7, the cutting depth is no greater than 0.100 inch.

9. The synthetic water main piercing tool apparatus of claim 1, wherein the material slot is a first material slot, the apparatus further comprising:
a second material slot formed in the hollow cylindrical bit body, the second material slot opening at the distal end of the hollow cylindrical bit body and extending from the distal end towards the proximal end.

10. The synthetic water main piercing tool apparatus of claim 1, wherein the synthetic water main is made from polyvinyl chloride (PVC).
